(19) United States
(12) Patent Application Publication
(10) Pub. No.: US 2002/0002542 A1
(43) Pub. Date: Jan. 3, 2002

(54) Information reproducing method and information providing business method

(76) Inventors: Hideo Ando, Hino-shi (JP); Hisashi Yamada, Yokohama-shi (JP); Akio Tanaka, Yokohama-shi (JP)

Correspondence Address: Pillsbury Winthrop LLP, Intellectual Property Group, 1600 Tysons Boulevard, McLean, VA, 22102, US

(21) Appl. No.: 09/835,822

(22) Filed: Apr. 17, 2001

(30) Foreign Application Priority Data
Apr. 17, 2000 (JP) 2000-115431

(51) Int. Cl. H04K 1/00; H04L 9/00; G06F 17/60

(52) U.S. Cl. 705/57

(57) ABSTRACT

A pay information providing service system charges each time the received information is decrypted, while maintaining high security, and enables temporary copying, thereby achieving a time shift function. To realize a tuner section, a display output control section, and a time shift function of shifting the display timing of the received information, there is provided a received information temporary storage section for storing the received information temporarily. To assure the security in realizing the time shift function, making use of the delivery time information sent from the transmission side, there are provided an allowed display time difference setting section, a totalized time shift time computing section, and a decrypting section. Furthermore, to charge properly, there are provided a user authenticating section, a charging information extracting section, and a received information control and charging section.

### CROSS-REFERENCE TO RELATED APPLICATIONS

This application is based upon and claims the benefit of priority from the prior Japanese Patent Application No. 2000-115431, filed Apr. 17, 2000, the entire contents of which are incorporated herein by reference.

### BACKGROUND OF THE INVENTION

This invention relates to an information reproducing method and an information providing business method.

The application field of the present invention includes cable telecommunication service, broadcasting communication service, information communication service, and information delivery service. In cable telecommunication service, the content provider, the transmission side, offers information to the user, the reception side, using a cable communication network or a telephone network. In broadcasting communication service, for example, digital television offers video information making use of conventional analog television, ground waves, or satellite-based communication. In information communication service, weather forecast information or specific still picture information is offered to the user making use of wireless telecommunication of cellular phones. In information delivery service, such as Internet information communication service, audio information or publication information on, for example, books, is offered via the WWW (World Wide Web) to the user's personal computer, making use of the Internet.

When the categories “transmission side,” “reception side,” and “information transfer medium” are used, these are the common points of the systems constituting the aforementioned service forms. The “transmission side” corresponds to a content provider in a wide sense that offers content information. The “reception side” corresponds to a plurality of users that receives service and pay for the service. The “information transfer medium” corresponds to means for transferring information between the transmission side and the reception side.

Specifically, the present invention relates to various technical fields or a variety of service fields where the system is composed of the “transmission side,” the “reception side,” and the “information transfer medium” that connects the “transmission side” and the “reception side.” The present invention further relates to an improvement in service forms aiming at progress in the contents of information service. Furthermore, the present invention relates to an improvement in a business form complying with a method whereby the provider charges its users for information service.

An analog picture broadcasting system is an example of a system constructed of the “transmission side,” the “reception side,” and the “information transfer medium.” The characteristics and problems of the broadcasting system will be explained.

A conventional analog-picture broadcasting system has a TV (Television) station, a content provider, as the “transmission side” and commercial radiowaves, including ground waves and satellite waves, as the “information transfer medium.” It further has a TV receiving device with an antenna for receiving the commercial radiowaves, a tuner, and a display section (including a Braun tube or a liquid-crystal panel) as the “reception side.” The “reception side” further includes ordinary users who enjoy watching the pictures on the display section.

The “reception side” is further provided with a recording medium, such as a VTR (Video Tape Recorder). It is possible to record the received video information temporarily onto the recording medium and, when the user wants, reproduce the recorded contents repeatedly.

A method of charging a viewing fee in analog TV broadcasting is to collect money from the sponsors in creating the contents in the case of commercial broadcasting stations, differently from the viewing fee collecting system of NHK (Japan Broadcasting Corp.). With this method, content providers are running their business.

In contrast, content providers that run a business using cable TV, WOWOW channel, or digital broadcasting, such as SKY PerfectTV or DirecTV, employ a method of charging the users, the “reception side,” a viewing fee.

In information providing business using a method of charging users a viewing fee, pay information, such as provided AV (audio-video) information or weather forecast information, may be recorded on a recording medium, such as a VTR on the “reception side.” If the recorded pay information were reproduced repeatedly free of charge or the pay information recorded on a VTR were further copied illegally and resold, this would be undesirable from the viewpoint of business.

To avoid this drawback, when the pay information is transferred to the “reception side” in digital form, the provided contents are encrypted and then transferred and simultaneously copy control information (that is, information as to whether copying is inhibited or permitted only once or allowed freely) is transferred as well. The copy control information realizes a method of prohibiting recording (or copying) from being done onto a recording medium. Furthermore, even when the encrypted pay information is recorded on a recording medium, the viewing fee is charged each time the encrypted pay information is reproduced on the recording medium and then decrypted.

In the system of charging the “reception side” a viewing fee, there have been the following demands. For example, when the user visits the restroom or receives an unexpected visitor when watching the AV information broadcast live on the TV receiver, the user may interrupt the playback temporarily and leave the room where the TV receiver is. In such a case, when the user returns to the room where the TV receiver is after a specific time has elapsed, the user may want the function of starting the playback where it was interrupted (that is, what is called a time shift function).

One method of realizing the time shift function is to record shift pay information onto the recording medium, such as an HDD (Hard Disk Drive), when the playback is interrupted, and reproduce and display the pay information recorded on the HDD, when the user comes back. On the other hand, the pay information currently being broadcast is kept being recorded onto the HDD.

However, the fact that, although the copy inhibit information is present, the time shift function is achieved using the HDD is a contradiction. The reason is that the copy inhibit information prohibits copying from being done on the HDD either.

As for the method of charging a viewing fee each time the encrypted pay information is recorded once on a recording medium, such as a VTR, reproduced, and decrypted, there is still no way of charging for information providing service capable of time shift. Therefore, a suitable charging system has been required. One reason for this is that the VTR function prevents the time shift function from being realized. Another reason is that, after the encrypted information is recorded on the tape of the VTR, the recorded encrypted information is reproduced and the state of encryption during reproduction is managed, thereby charging a viewing fee.

### BRIEF SUMMARY OF THE INVENTION

An object of the present invention is to provide an information reproducing method and an information providing business method which enable temporary copying and a time shift function to be realized even in a system which provides pay information service and charges when the received information is decrypted and which is provided with copy inhibit information.

Another object of the present invention is to provide an information reproducing method and an information providing business method which enable the time shift time to be managed.

Still another object of the present invention is to provide an information reproducing method and an information providing business method which enable viewing fees to be charged properly.

To accomplish the foregoing objects, the present invention comprises a selective combination of the following steps or means:

(A) The “transmission side,” when delivering information, transfers the encrypted delivery time information 3 together with the encrypted information offered to the user to the “reception side.”

(B) Even after the delivery of the information has been completed, the “transmission side” continues transferring the encrypted delivery time information 3 to the “reception side,” thereby enabling the time shift function.

(C) When the execution of time shift is necessary, the reception/display control unit 10 on the “reception side” continues recording the encrypted information to be offered to the user transferred from the “transmission side” and the simultaneously transferred encrypted delivery time information 3 into the received information temporary storage section 18.

(D) At the time of display after the time shift, the present encrypted delivery time information transferred from the “transmission side” is recognized as the present time and the time difference between the present time and the past encrypted delivery time information 3 recorded in the received information temporary storage section 18, thereby calculating the time shift time.

(E) The time shift enable time set at the allowed display time difference setting section 8 is compared with the time shift time calculated in item (D).

(F) When the time shift time is shorter than the time shift enable time in item (D), the encrypted information to be offered to the user recorded in the received information temporary storage section 18 is decrypted. The decrypted information is displayed for the user. Conversely, when the time shift time is longer than the time shift enable time, it is judged that display is impossible and a warning that display is inhibited because the time shift enable time has been exceeded is given to the user in sound or in pictures (including still pictures).

(G) The charges for information providing service are added to the regular charges according to the preset length of the time shift enable time. Alternately, the charges are increased according to the length of the time shift display time.

(H) The encrypted delivery time information 3 is decrypted using the user key, thereby preventing the leakage of the delivery time information 3, which assures high security.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows an overview of an information providing business according to the present invention;

FIG. 2 is a block diagram of the reception/display control unit 10 of FIG. 1;

FIG. 3 shows an example of a delivery information transmission form in the information providing business according to the present invention;

FIG. 4A shows the packet group and the contents of the program association table of FIG. 3 in detail;

FIG. 4B shows the packet group and the contents of the program map table of FIG. 3 in detail;

FIG. 4C shows the packet group and a collection of video and audio streams in program 1 of FIG. 3;

FIG. 5 shows a collection of video information in program 1 of FIG. 3 in further detail;

FIG. 6 is a diagram to help explain the packet group, conditional access table, delivery time information header and encryption delivery time information, and key information header and encryption title key information;

FIGS. 7A and 7B are flowcharts to help explain a time shift process related to the present invention from the viewpoint of recording information into a received information temporary storage section;

FIGS. 8A and 8B are flowcharts to help explain the time shift process from the viewpoint of reproducing the information from the received information temporary storage section;

FIGS. 9A and 9B are flowcharts to help explain an example of a charging system in realizing the time shift process;

FIG. 10 is a diagram to help explain an example of constructing a network to which the information providing business method of the present invention is applied; and

FIG. 11 is a flowchart to help explain the operation of the information processing unit on the provider side using the information providing business method of the present invention.

### DETAILED DESCRIPTION OF THE INVENTION

Hereinafter, referring to the accompanying drawings, an embodiment of the present invention will be explained.

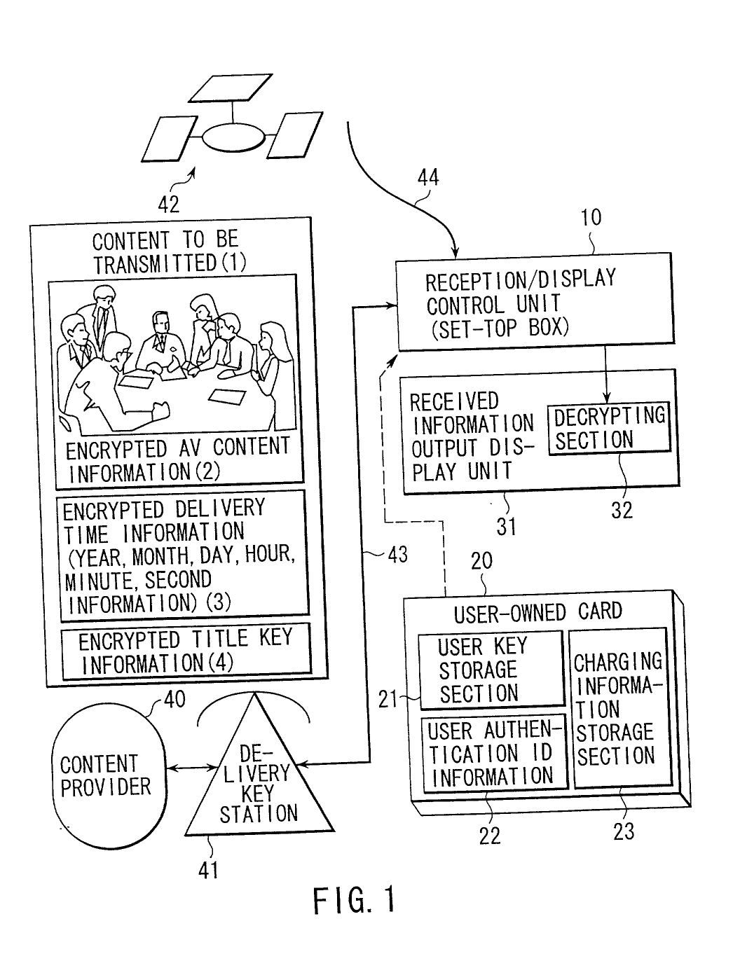

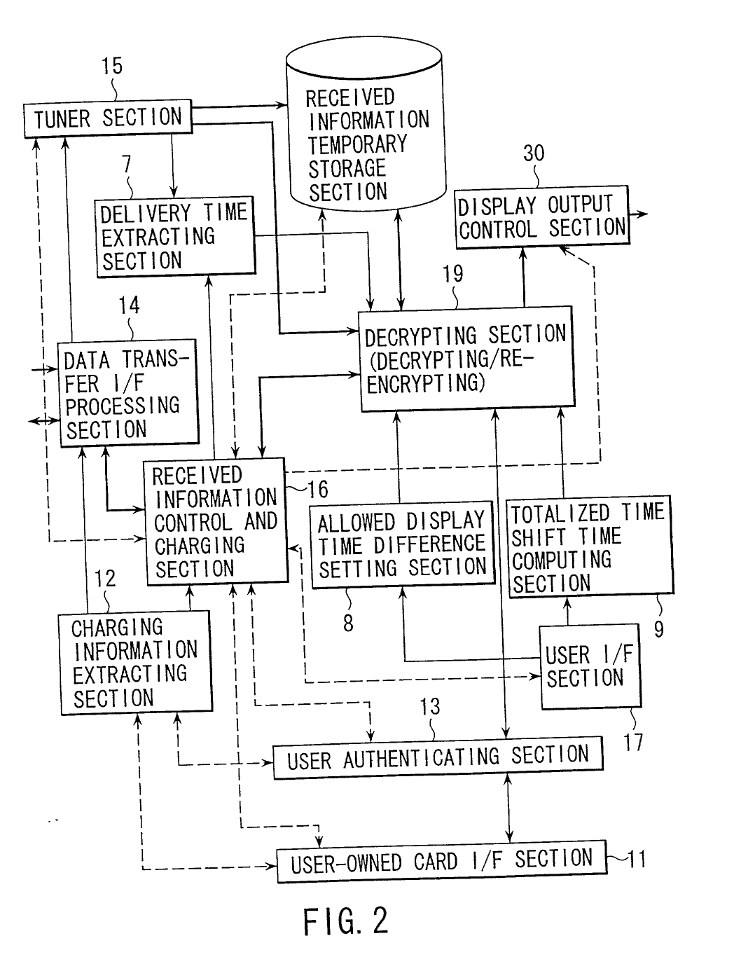

Using FIGS. 1 and 2, an outline of the present invention will be given, followed by a more detailed explanation. FIG. 1 shows an overview of an information providing service system to which the present invention has been applied. FIG. 2 shows the internal configuration of the reception/display control unit 10 (for example, a set top box: STB) 10 in the system in detail.

In the present invention, the range covering a content provider 40 that offers information providing service and a delivery key station 41 and a delivery satellite 42 which relay the information to enable the content provider 40 to offer the information to ordinary users is defined as the “transmission side.” There is an “information transfer medium” serving as a path for delivering the information between the delivery key station 41 or delivery satellite 42 and the devices of ordinary users. The “information transfer medium” includes a wireless delivery network 44, the generic name for ground waves, satellite waves, and commercial radiowaves used for mobile phones, and a cable delivery network 44, the generic name for a cable communication line used for cable TV, a telephone network, and a LAN (Local Area Network) provided in a building or a company. Moreover, IEEE (Institute of Electrical and Electronics Engineers) 1394 communication lines whose transfer distance has far extended in recent years are also included in the “information transfer medium” in the present invention.

In the present invention, the contents of information offered to the users include AV (Audio Video) information and Data information:

(1) AV (Audio Video) information includes video information, such as analog TV or digital TV, audio information delivered over AM (Amplitude Modulation)/FM (Frequency Modulation) radio, video information complying with the MPEG (Moving Picture Experts Group) 4 standard transferred over the Internet, audio information complying with the MPEG-3 (MPEG Audio Layer 3) standard or ACC (Advanced Audio Coding) standard, and still-picture information complying with the JPEG (Joint Photographic Coding Experts Group) standard.

(2) Data information includes weather forecast information, news, map information, gourmet information, and general document information.

In the present invention, the front-end user side to which the information is delivered from the “information transfer medium” is defined as the “reception side.” Specifically, in FIG. 1, the “reception side” includes the reception/display control unit 10, a received information output display unit 31 connected to the reception/display control unit 10, and ordinary users (not shown) who enjoy the displayed images or sound on the received information output unit 31.

In FIG. 2, explanation will be given on the assumption that a display output control section 30 is included in the reception/display control unit 10 of FIG. 1. The received information output display unit 31 and display output control section 30 may be integrally formed or part of the received information output display unit 31 may be further separated. In these cases, too, the contents of the present invention hold.

The contents of the present invention can be applied to the following system: in the system, the “reception side” transfers the information in order that ordinary users who use an interactive communication system, such as video-on-demand service, make a request or an answer directly to the content provider 40 or that the content provider 40 collects charging information about its ordinary users.

To enable the time shift function in the reception/display control unit 10 for only a specific length of time when the copy inhibit information is transferred from the “transmission side,” it is necessary to have a clock for measuring the time shift time. Just providing a clock in the reception/display control unit 10, however, makes it possible to externally manipulate the time on the clock, enabling illegal use, regardless of the copy inhibit information.

In the present invention, encrypted AV information, together with transmission time information or deliver time information 3, is delivered, regardless of wire or wireless systems. The deliver time information 3 is encrypted and cannot be decrypted unless the user key information recorded in the user key storage section 21 within a user-owned card 30. The decrypting process is carried out at a decrypting section 19 composed of only a single chip. Accordingly, the method of the present invention is characterized by preventing the time information from being externally changed easily and assuring a great security.

The content 1 to be transmitted includes encrypted AV content information 2. It also includes encrypted title key information 4 for decrypting the AV content information 2. Furthermore, it includes encrypted delivery time information 3 characteristic of the present invention.

The delivered content 1 is inputted to a tuner section 15 via a data transfer I/F processing section 14. The tuner section 15 extracts the content 1. The encrypted delivery time information 3 is transferred to a delivery time extracting section 7. Using user key information, a decrypting section 19 decrypts the delivery time information 3. The decrypted information is used as the present time information. At this time, in the present system, the user key information is used to decrypt title key information decrypting key, which will be explained later. The title key information decrypting key is used to decrypt the encrypted title key information.

While the received information is being displayed in real time, the received information is sent directly from the tuner section 15 to the decrypting section 19. When a user I/F section 17 receives a pause (temporary stop) instruction signal from the user, the received information starts to be recorded temporarily into a received information temporary storage section (HDD) 18. At this time, a totalized time shift time computing section 9 starts a time counting operation.

Thereafter, when a playback start instruction is received from the user, the encrypted AV content information 2, title key information 4, and encrypted delivery time information 3 recorded in the received information temporarily storage section 18 are sent to the decrypting section 19.

At this time, the value (Ts) of the difference between the temporarily stored preceding delivery time and the present time (or the present delivery time information immediately after the reception) is compared with the count (or time shift value) of the totalized time shift time computing section 9, thereby making sure that there is no illegal processing (for example, illegal amendments to the totalized time shift time). Thereafter, the difference value (Ts) is compared with the maximum time shift time (Tm) previously set at an allowed display time difference setting section 8.

When time shift display is possible (Ts<Tm), the AV content information taken out of the received information temporary storage section 18 is decrypted. When time shift display is impossible (Ts>Tm), a warning is displayed on a received information output display unit 31.

Using sound or images (including still pictures), the warning display warns the user against prohibition on display due to the expiration of the time shift allowed time.

This invention enables time shift for the delivery information including the copy inhibit information and can charge for the time shift.

To realize this, the delivery time information continues being delivered even after the delivery of the AV content information has been completed. The present invention is characterized by enabling a business by changing the amount of charges according to the maximum time shift enable time or the time during which time shift was actually effected.

A charging method includes an on-line charging method using a wire delivery network 43 after the authentication of the user using a user-owned card 20 on which the user ID information has been recorded or a charging method based on a prepaid system using the user-owned card 20 as a prepaid card. A command is transmitted from the “transmission side” via the wire delivery network 43 to the user-owned card 20, which enables the prepaid fee to be changed.

The configuration of FIG. 1 and that of FIG. 2 will be explained concretely.

The content 1 to be transmitted is directed via the wire delivery network 43 or wireless delivery network 44 to the data transfer I/F processing section 14 in the reception/display control unit 10. The data transfer I/F processing section 14 transfers the taken-in information to the tuner section 15, which select the channel.

In a normal reception or display state, the AV content information 2 and encrypted title key information 4 are directed to the decrypting section 19 and the encrypted delivery time information 3 is directed to the delivery time extracting section 7.

When the user-owned card 20 is inserted into the user-owed I/F section 11, a user authenticating section 13 carries out a user authenticating process. The user-owned card 20 has a user key storage section 21 and a user authentication ID information storage section 22. The user authenticating section 13 compares the user authentication ID information with the user authentication ID information registered in the user authenticating section 13, thereby performing authentication. When the user authentication ID information coincides with the registered user authentication ID information, the decrypting section 19 decrypts the title key information 4 using the user key information in the user key storage section 21. The user key information is such that it is sent from, for example, the content provider and stored in the user key storage section 21.

Using the decrypted title key information 4, the decrypting section 19 decrypts the encrypted AV content information 2. The decrypted AV content information 2 is encrypted again using the IEEE 1394 standard. The resulting information is then supplied via the output display control section 30 to the decrypting section 32 of the received information output display unit 31.

As a result, the received information output display unit 31 can decrypt the AV content information 2, display the decrypted information, and further output sound.

A received information control and charging section 16 causes a charging information extracting section 12 to monitor whether the balance is recorded on the user-owned card 20. If the balance is still positive, the decrypting section 19 permits a content decrypting process. If the balance is zero, a warning signal is sent to provide a warning display as described earlier. If the balance is running short, the balance information is automatically transferred via the data transfer I/F processing section 14 to the content provider. If necessary, the content provider can make up the prepaid balance.

Next, a case where the time shift function is used will be explained.

When the user stops viewing the program in the middle, the pause button in the user I/F section 17 is pressed to make a pause. Thereafter, when the user resumes viewing the program, the pause button in the user I/F section 17 is pressed to cancel the pause. The time (time shift time) from when the viewing was interrupted until it is started again is measured at the totalized time shift time computing section 9. In the measurement, the time of one interruption may be measured and at the same time, the total time of interruptions may be totalized, even when the viewing is interrupted and resumed repeatedly. The totalizing process is carried out, while the contracted program is being viewed.

On the other hand, when the pause button is pressed, the delivery time information 3 currently being sent to the delivery time extracting section 7 and the title key information 4 currently being sent to the decrypting section 19 are stored temporarily in the received information storage section 18.

Thereafter, when a resume instruction is given (or the pause is canceled), the present delivery time information is sent via the delivery time extracting section 7 to the received information control and charging section 16. In addition, the old delivery time information stored in the received information temporary storage section 18 is sent to the received information control and charging section 16. The received information control and charging section 16 calculates the difference between the present delivery time information and the old delivery time information, thereby finding the time difference. Then, the section 16 compares the time difference (difference value: Ts) with the interrupt time (Tc) measured by the totalized time shift time computing section 9.

When the comparison has shown that they coincide with each other (Ts=Tc) and there is no illegality, the section 16 compares the difference value (Ts) with the maximum time shift time (Tm) previously set in the allowed display time difference setting section 8. Only when time shift display is possible (Ts<Tm), the section 16 decrypts the AV content information. When time shift display is impossible, a warning is displayed on the received information output display unit 31. Here, the time difference (difference value: Ts) and the interrupt time (Tc) measured by the totalized time shift time computing section 9 may not coincide with each other accurately, as long as the error does not exceed the allowed value.

When the pause time has exceeded the maximum time shift time, there are various methods of dealing with subsequent information processes.

For instance, (1) when the pause is canceled, the message “MAXIMUM TIME SHIFT TIME HAS BEEN EXCEEDED” is displayed to give a warning and the reproduction is ended. (2) When the pause is canceled, the message “MAXIMUM TIME SHIFT TIME HAS BEEN EXCEEDED” is displayed to give a warning and the message “RESUMING THE VIEWING WILL CAUSE PART OF THE PERIOD AFTER THE PAUSE TO BE CUT OFF.” When the user operates to resume the viewing, reproduction is started from the content corresponding to the maximum time shift time, going back from the present time. When the user operates to end the process, the reproduction is completed.

The maximum time shift time (Tm) may be set in the allowed display time difference setting section 8 via the user I/F section 17. When the viewing is resumed after the interruption of the viewing, the maximum time shift time (Tm) is subjected to the aforementioned comparing processes at the received information control and charging section 16.

For example, there are the following two methods of setting the maximum time shift time (Tm):

(1) One method is to set the maximum time shift time allowable in one interruption. In this case, the difference value (Ts) and Tm are used as described above and whether the viewing is permitted or not is determined, depending on which of the two is larger than the other.

(2) The other method is to set the maximum time shift time (assuming interruption and resumption are repeated more than once) allowable only in one program. In this case, the totalized shift time when interruption and resumption are repeated is compared with the totalized difference value obtained by totalizing the difference values. Only when the totalized difference value is smaller than the totalized shift time, decryption (viewing) is permitted.

Another method of permitting the viewing in connection with the maximum time shift time is as follows: (3) a method of setting the length of time that allows one interruption as the maximum time shift time and, when the number of interruptions has reached n, prohibiting the viewing. In this case, there is provided a block (routine) for counting the number of interruptions in a single program. Since the larger the number of interruptions, the greater the amount of information stored in the received information temporary storage section 18, it stands to reason that the length of time should be set according to the limit of the memory capacity of the received information temporary storage section 18.

It has to be avoided that the maximum time shift time is set to infinite. Accordingly, the maximum shift time previously sent from the provider may be stored in the allowed display time difference setting section 8.

Next, there are two methods of charging for the time shift process:

(1) One method is to multiply the length of interruption time in minutes obtained from the aforementioned difference value by a unit price set by the provider as a coefficient and subtract the result from the balance information.

(2) The other method is to set the maximum time shift time once and determine the price automatically according to the length of the maximum time shift time, regardless of whether the maximum time shift time is spent or not.

The charging information extracting section 12 extracts the balance information stored in the charging information storage section 23 of the user-owned card 20 and transfers the balance information to the received information control and charging section 16 or writes the balance information calculated at the received information control and charging section 16 into the charging information storage section 23. Furthermore, the section 12 can inform the provider of the balance information via the data transfer I/F processing section 14 and write the new balance information (prepaid balance) transferred from the provider into the charging information storage section 23 of the user-owned card 20 or do supplementary writing to the latter.

In the system of FIG. 2, the individual blocks may be composed of separate units. They may be composed of in other ways. For instance, the decrypting section 19 may be made up of a single chip unit, each of the user I/F section 17 and user-owned card I/F section be made up of a unit, the received information temporary storage section 18 be composed of a unit made up of a hard disk and its drive, each of the data transfer I/F processing section 14 and tuner section 15 be composed of a unit, and the remaining sections be composed of software in the system controller (not shown).

Next, an example of the format of the information transmitted from the wire delivery network 43 and wireless delivery network 44 will be explained.

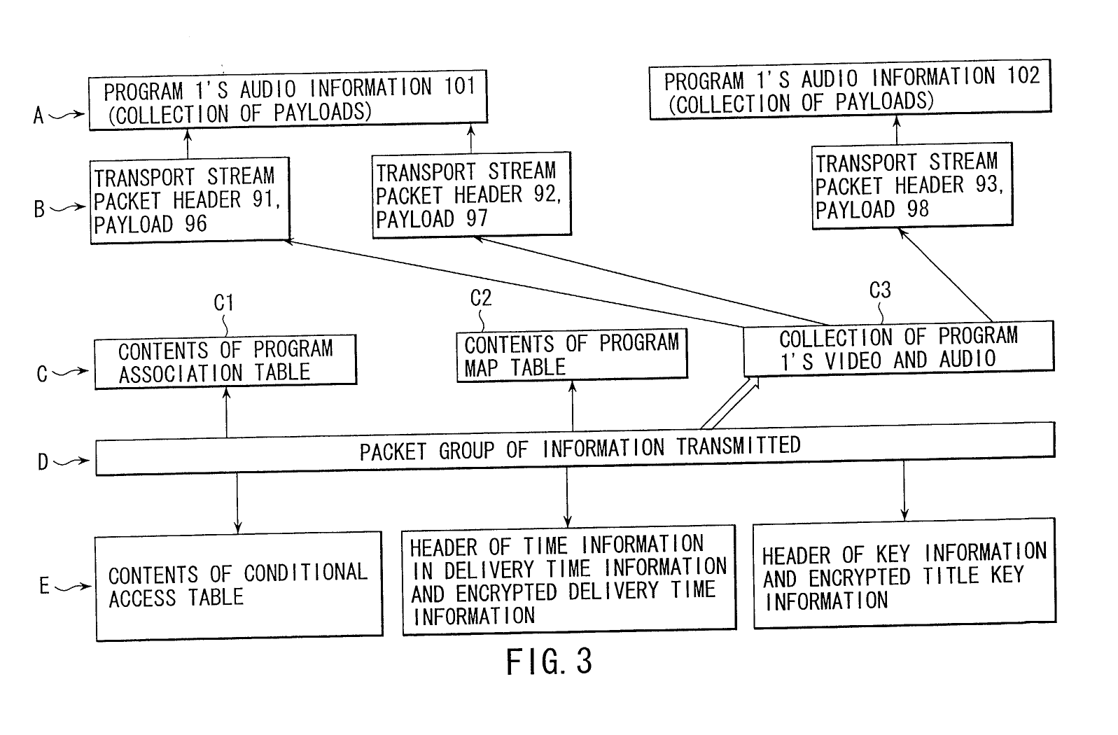

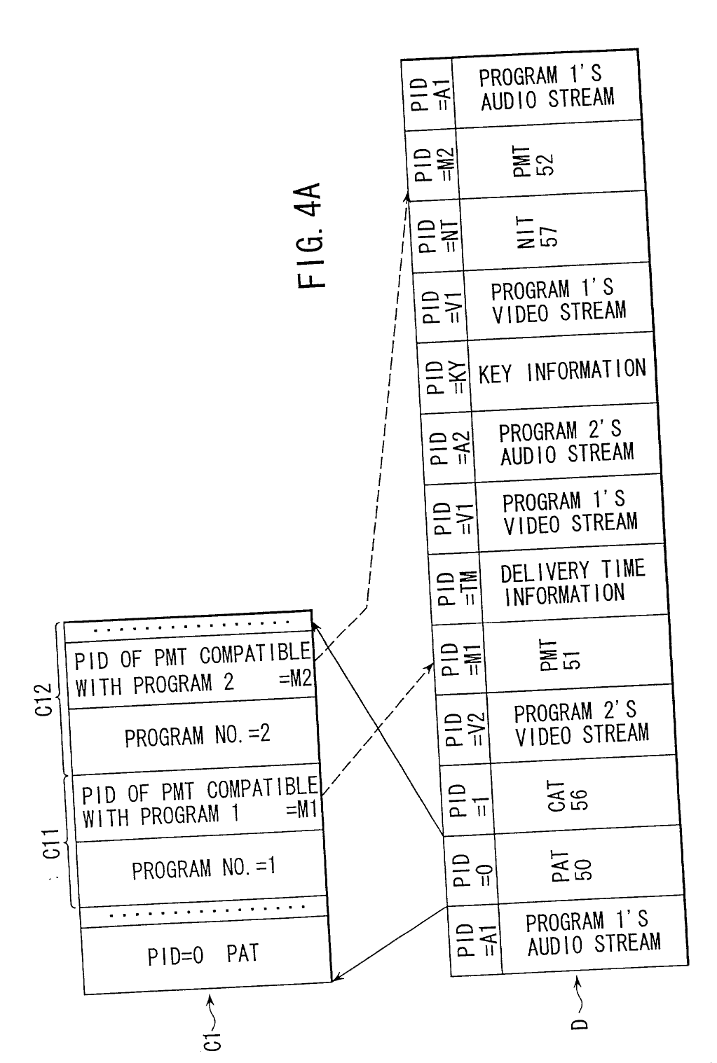

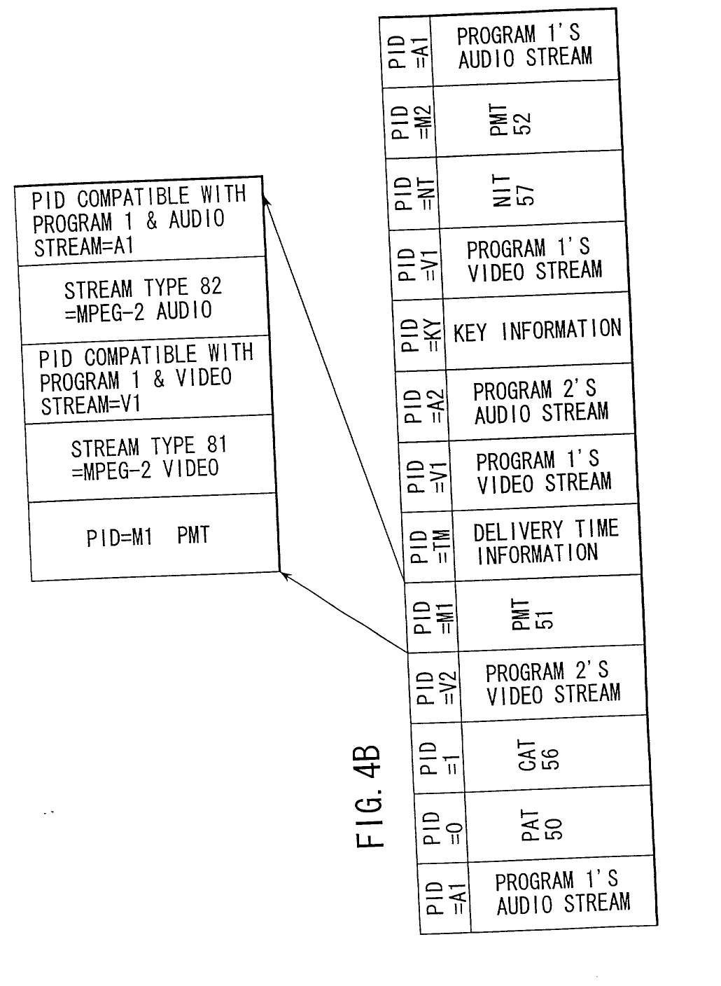

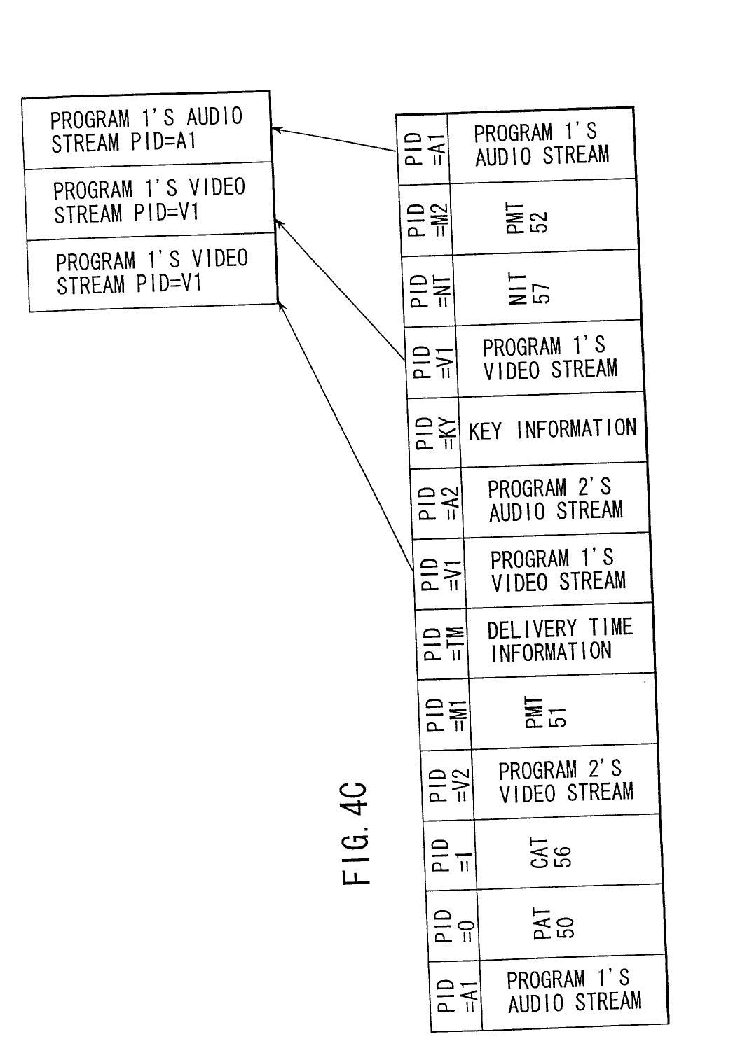

A packet group of the information transmitted is shown by the letter D in FIG. 3. Each packet has a packet header, in which packet identification information (PID) (see FIGS. 4A to 4C) is written. In the packet group, there are a program association packet C1 and a packet C2 including the contents of a program map table as shown by the letter C in FIG. 3. In addition, there are video packets and audio packets for a plurality of programs. A collection of program 1's video packet and audio packet is shown by the letter C in FIG. 3.

FIG. 4A shows the contents of D and C1 in FIG. 3 more concretely.

The program association packet C1 includes a program association table (PAT). The PAT specifies the packet identification (PID) for each channel, that is, packet identification information. The individual channels have packet C11 including information (PMT explained later) used to process program 1 and packet C12 for information (PMT explained later) used to process program 2 in this example. The packets including the contents of the program map table (PMT) include the relevant program map table (PMT). The table, for example, related to program 1, includes PID of the program map table corresponding to the video stream of program 1 and PID of the program map table corresponding to the audio stream of program 1. In the example of FIG. 4A, M1 and M2 are written in the separate packets as shown by broken-line arrows.

FIG. 4B shows the contents of PID=M1 in further detail. In the contents of PID=M1, the packet ID necessary to collect a video stream packet and an audio stream packet for program 1 is written. In addition, the video attribute information and audio attribute information are written as stream type.

FIG. 4C illustrates a collection of a video stream packet and an audio stream packet for program 1.

In FIG. 3, the collection of the video and audio packets of program 1 shown by the letter C in FIG. 3 is further broken apart, which is shown by the letter B in FIG. 3. The contents of each packet shown by the letter B in FIG. 3 include a transport stream packet header and a payload attendant on the transport stream packet header. A collection of the payloads is shown by the letter A in FIG. 3.

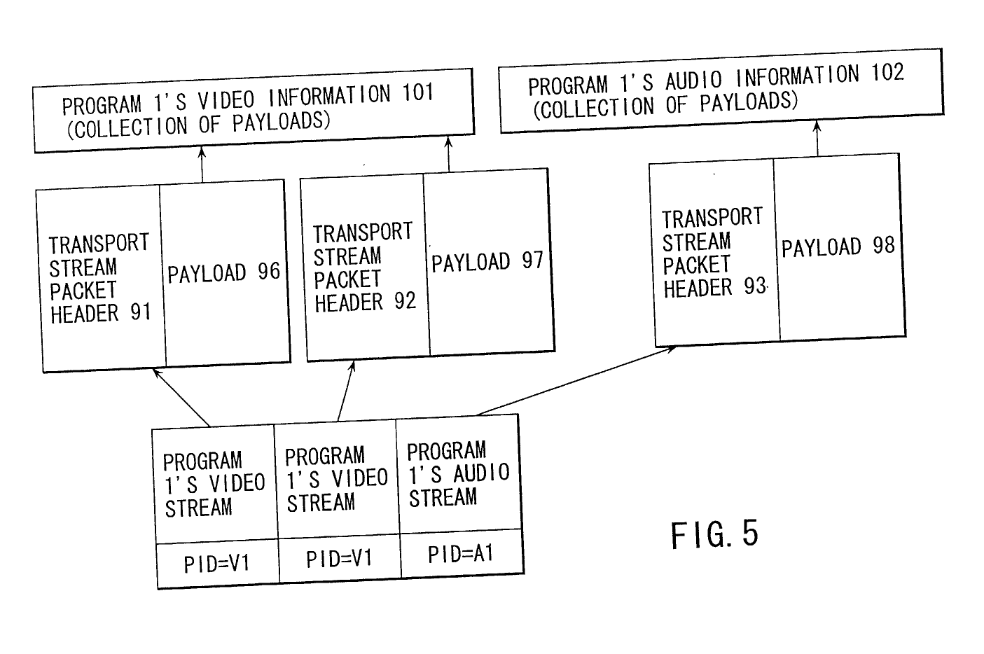

FIG. 5 illustrates what are shown by the letters A, B, and C in FIG. 3 and FIG. 4C in further detail.

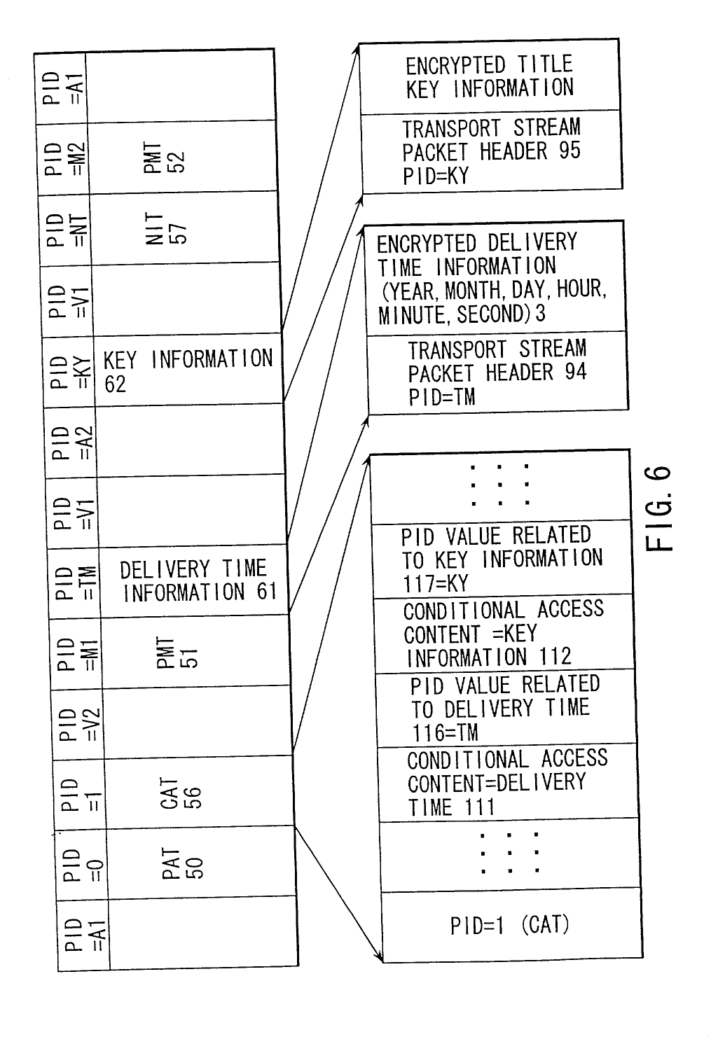

In FIG. 3, the letter E indicates a packet including a conditional access table (CAT) included in the packet group of the transferred information, a packet including the encrypted deliver time information, and a packet including the encrypted title key information. FIG. 6 illustrates the contents of these in detail.

Using FIGS. 4A to 4C, the contents of the packet including PAT in the transferred packet group and the contents of the packet including PMT will be explained.

Each of the transferred packets has PID written at its head, thereby enabling the type of the packet to be identified. Each packet contains 188 bytes and conforms to the MPEG standard and is designed to be capable of transferring a plurality of programs.

The PID of the PAT is determined to be 0. When the PID packet is taken out in reception, the PID of the PMT of each program can be known from the information in the packet. In the example of FIG. 4A, the PID corresponding to program No. 1 is M1 and the PID corresponding to program No. 2 is M2.

Now, if program No. 1 is selected for viewing, the packet with PID=M1 is extracted. As shown in FIG. 4B, in PID=M1, the stream type (for example, MPEG-2 video) and the PID (=V1) of the packet in which program 1's video stream paired with the stream type is located have been written. Following this, the stream type (for example, MPEG-2 audio) and the PID (=A1) of the packet in which program 1's audio stream paired with the stream type is located have been written. Each packet is extracted or selected mainly at the tuner section 15.

The packet extracting section extracts the desired packets on the basis of the PID value and collects them. In the example of FIG. 4C, two program 1's packets V1 and one program 1's packet A1 have been collected. The packet extracting section may be provided in the decrypting section 19 or separately.

FIG. 5 illustrates the collected packets and their contents. In each packet, the PID is present at the beginning of the transport stream packet header located at the head of the packet. Following the header, a payload is present. In FIG. 5, numeral 91 indicates the transport stream packet header of the first packet in the video stream, numeral 96 the payload paired with the transport stream packet header, numeral 92 the transport stream packet header of the second packet, and numeral 97 the payload paired with the transport stream packet header of the second packet. Numeral 93 indicates the transport stream packet header of the audio stream packet and numeral 98 the payload paired with the transport stream packet header of the audio stream packet.

The information to be actually decrypted is the payloads. The individual video payloads are extracted and put together and the individual audio payloads are extracted and put together. The collection of video payloads and that of audio payloads are decoded (or decrypted) separately. In FIG. 5, a collection of program 1's video information 101 and a collection of program 1's audio information 102 are shown separately. In the transport stream header, time stamp information for synchronizing the video with the corresponding audio is written and used in controlling the decoder.

FIG. 6 shows the contents of the conditional access table (CAT 56), a packet characteristic of the present invention, the contents of the delivery time information 61, and the contents of the key information 62 in detail.

The PID of a packet including a CAT is determined to be 1. In the CAT, its PID and conditional access content (flag) 111 (=indicating that the subsequent information is the PID value of the delivery time information packet) paired with the PID (=TM) concretely indicating the position of the delivery time information packet have been written. Following this, conditional access content (flag) 112 (=indicating that the subsequent information is the PID value of the key information packet) paired with the PID (=KY) concretely indicating the position of the key information packet have been written.

Therefore, with the packet extracting section, the extraction of the PID (=TM) packet enables the delivery time information to be known and the extraction of the PID (=KY) packet enables the key information to be extracted. FIG. 6 shows the contents of the delivery time information 61 and the contents of the key information 62. In the delivery time information packet, its PID (=TM) and the encrypted delivery time information following the PID have been written. The delivery time information includes information about the year, month, day, hour, minute, and second of the relevant program. The key information packet includes its PID (=KY) and the encrypted title key information.

Referring to the control information (including PID, PAT, CAT, and PMT) as described above, the system of the present invention can acquire information about the streams of the desired program and decrypt the acquired information.

The present invention is characterized by transferring the encrypted delivery time information 3 and encrypted title key information 4.

An example of the operation of the system related to the present invention which processes the information on the basis of the above-described example of the format will be explained by reference to flowcharts.

The received information temporary storage section 18 has the function of recording the information from the tuner section 15 sequentially and the function of reading the recorded information and sending it to the decrypting section 19. These two functions operates simultaneously.

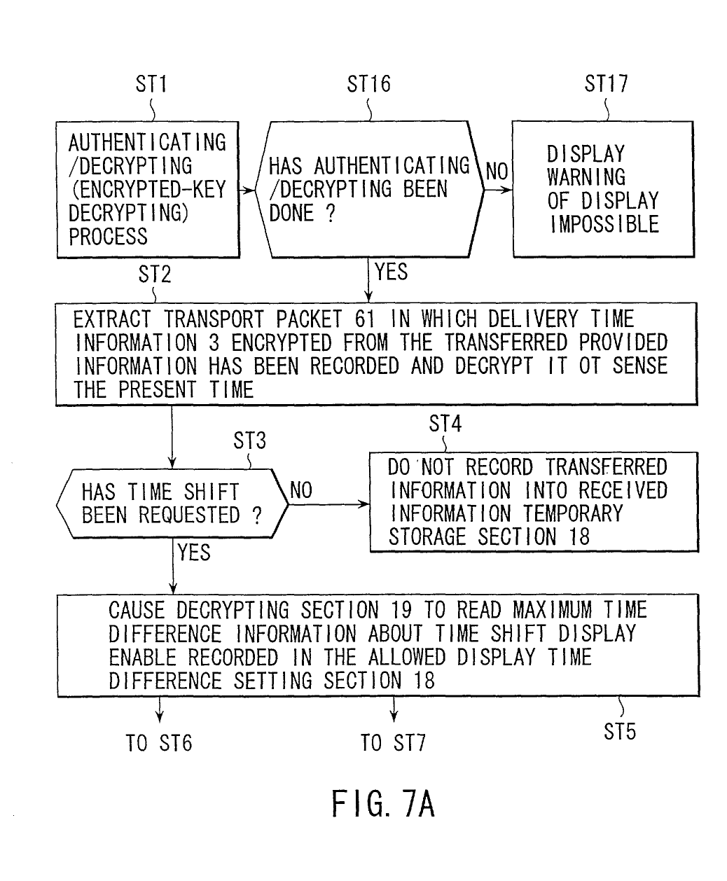

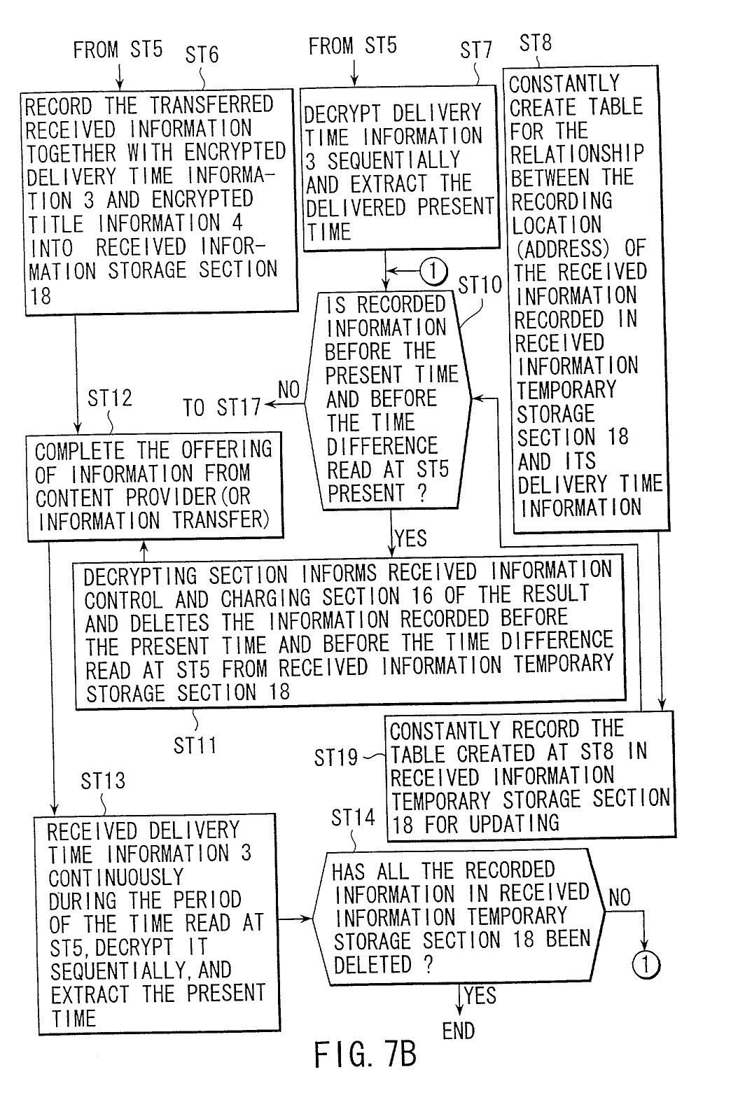

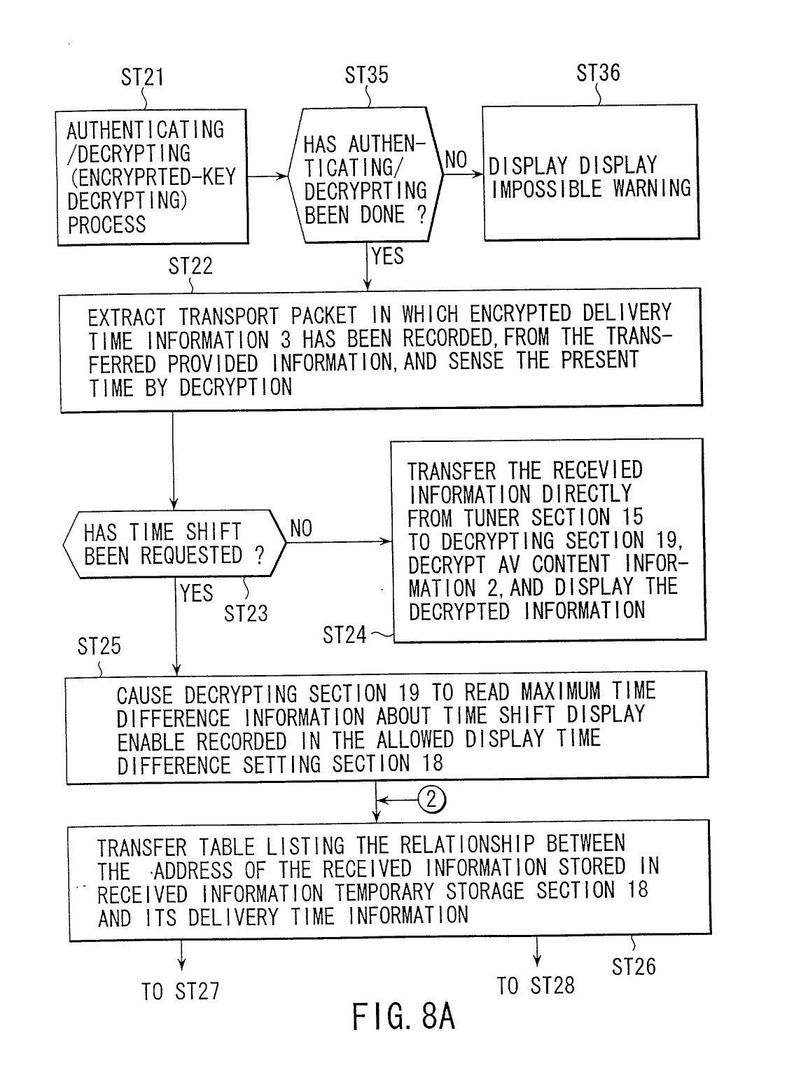

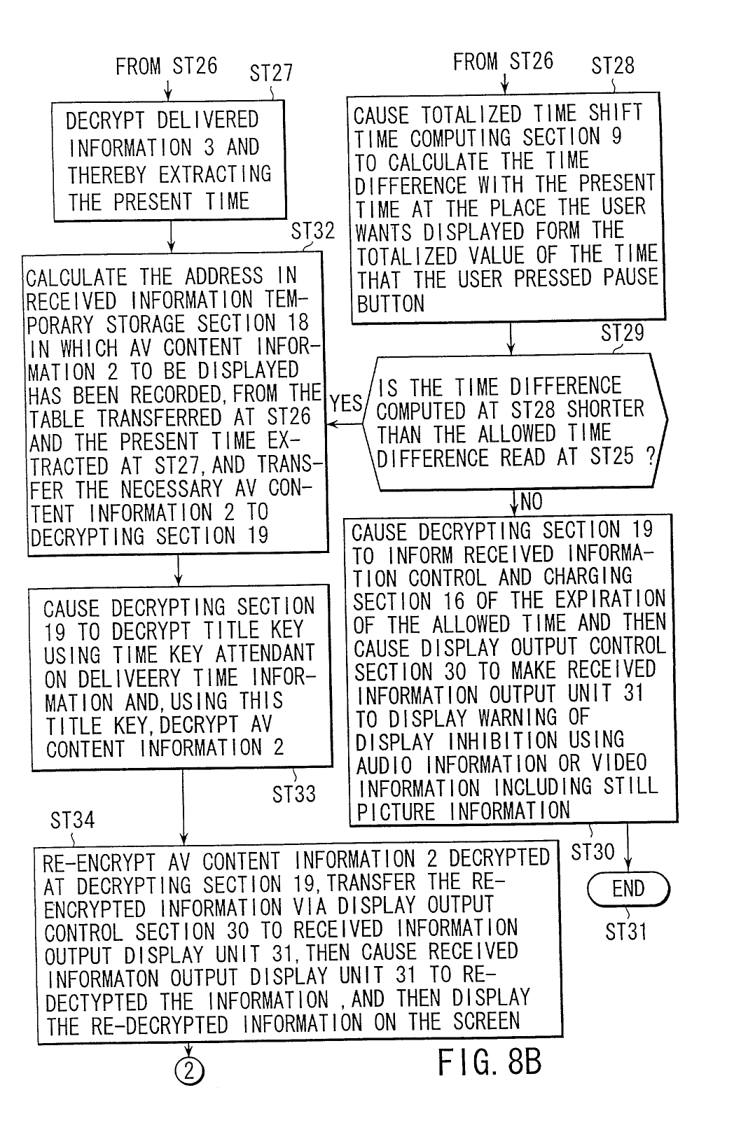

FIGS. 7A and 7B are flowcharts for the time shift process from the viewpoint of recording the information in the received information temporary storage section 18. FIGS. 8A and 8B are flowcharts for the time shift process from the viewpoint of reproducing the information from the received information temporary storage section 18.

In FIGS. 7A and 7B, the authenticating/decrypting (encrypted-key decrypting) process is carried out as described above (step S1) and it is judged whether authenticating/decrypting has been done (step S16). If authenticating/decrypting has not been done, the above-described warning will be displayed. If authenticating/decrypting has been done correctly, the tuner section 15 will extract the transport packet 61 (PID TM) in which the encrypted delivery information 3 is present and decrypt the transport packet 61, thereby recognizing the present time (step ST2). The delivery time information is decrypted at the decrypting section 19. At the same time, it is judged whether a request for time shift has been made (step ST3). If there is no request for time shift, the transferred information will not be recorded into the received information temporary storage section 18 (step ST4).

The presence of a request for time shift is determined by judging whether a pause operation is actuated from the user I/F section 17. If a request for time shift has been made, control will proceed to step ST5, where the maximum time shift time (the maximum time difference information for permitting time shift display) set in the allowed display time difference setting section 8 will be read.

Since display is interrupted at this time, the received delivery time information 3 is decrypted sequentially to recognize the delivered present time (step ST7). On the other hand, the received information (including the encrypted delivery time information 3, encrypted title key information 4, and encrypted AV content information 2) is put together and recorded in the received information temporary storage section 18.

At step ST7, a table of the relationship between the location in which the received information has been recorded in the received information temporary storage section 18 (or the address in the received information temporary storage section 18) and delivery time information (step S8) is created each time, while the present time is being recognized (step S8). Then, the table created at step ST8 is recorded in the received information temporary storage section 18 to update the old table (step ST9). At the same time, it is judged whether there is the information recorded before the present time and before the preceding maximum time shift time (step ST10). If there no such information, control will return to step ST7. If there is such information, control will proceed to step ST11.

At step ST11, the decrypting section 19 informs the received information control and charging section 16 of the result of the above judgment. Then, the received information control and charging section 16 gives an instruction to delete the previously recorded information (corresponding to the maximum time shift time) from the received information temporary storage section 18.

Here, even when the content provider has finished offering (or transferring) the information (step ST12), the delivery time information 3 is allowed to be received continuously for the period of the time difference (or for the maximum time shift time) read at step ST5 and the present time is recognized on the basis of the delivery time information 3 (step ST13), while the delivery time information is being decrypted sequentially. That is, in the information service of the present invention, business is run in such a manner that, even when the main information has been offered, only the delivery time information is still transferred continuously. This is characteristic of the present invention. The continuation of the transfer of the delivery time information realizes the time shift process after the program has been completed.

Next, it is judged whether all the recorded information in the received information temporary storage section 18 has been deleted (step ST14). If all the received information has been deleted, the process will be completed. If any of the received information has been left, control will return to step ST10. The fact that all the received information has been deleted means that the offering of the information has been completed during the interruption due to the time shift.

Referring to FIGS. 8A and 8B, the time shift process will be explained from the viewpoint of reproducing the information from the received information temporary storage section 18.

As described above, the authenticating/decrypting (encrypted-key decrypting) process is carried out (step S21) and it is judged whether authenticating/decrypting has been done (step S35). If authenticating/decrypting has not been done, the above-described warning will be displayed (step S36). If authenticating/decrypting has been done correctly, the tuner section 15 will extract the transport packet 61 (PID=TM) in which the encrypted delivery information 3 is present and decrypt the transport packet 61, thereby recognizing the present time (step ST22). The delivery time information is decrypted at the decrypting section 19. At the same time, it is judged whether a request for time shift has been made (step ST23). If there is no request for time shift, the transferred information will not be recorded into the received information temporary storage section 18. The tuner section 15 transfers the received information directly to the decrypting section 19, which decrypts the AV content information 2 sequentially and displays the decrypted information (step S24).

The presence of a request for time shift is determined by judging whether a pause operation is actuated from the user I/F section 17. If a request for time shift has been made, control will proceed to step ST25, where the maximum time shift time (the maximum time difference information for permitting time shift display) set in the allowed display time difference setting section 8 will be read.

Since the table for the relationship between the location in which the received information has been recorded and its delivery time information has been constructed within the received information temporary storage section 18 as described earlier (steps ST8 and ST9 in FIG. 7B), the table information is transferred to the received information control and charging section 16 (step ST26). Then, in parallel with this, the delivery time information 3 is decrypted sequentially, thereby recognizing the delivered present time information (step ST27). Further in parallel with the transfer, the user I/F section 17 calculates the time difference with the present time at the place the user wants displayed from the totalized value of the time that the user pressed the pause button (step ST28). The time difference is calculated at, for example, the totalized time shift time computing section 9.

It is judged whether the time difference calculated at step ST28 is shorter than the allowed time difference read at step ST25 (step ST29). If the former is shorter than the latter, control will proceed to step ST32, where time shift display will be realized. If the former is longer than the latter, control will proceed to step ST30, a warning will be displayed or sounded. For instance, the decrypting section 19 informs the received information control and charging section 16 of the expiration of the permitted time. Then, the output display control section 30 causes the received information output display unit 31 to display a warning of display inhibition using audio information or video information including still pictures and then completes the operation (step ST31).

At step ST32, the address in the received information temporary storage section 18 where the AV content information 2 to be displayed has been recorded is calculated from the table listing the relationship between the address of the received information and its delivery time and from the previously recognized present time. Then, the corresponding AV content information 2 is transferred to the decrypting section 19.

Next, the decrypting section 19 decrypts the title key using the time key attendant on the delivery time information. Then, using the title key, the AV content information 2 is decrypted (step ST33).

Next, the AV content information 2 decrypted at the decrypting section 19 is encrypted again. The resulting information is transferred via the output display control section 30 to the received information output display unit 31. The received information output display unit 31 decrypts the AV content information 2 again and displays the decrypted information on the screen (step ST34). Then, control returns to step ST26.

An additional explanation of step ST32 will be given. The encrypted delivery time information (numeral 61 in FIGS. 4A to 4C) includes the present time (year, month, day, hour, minute, second) and the title key decryption key in such a manner that they are put together into a set. Decrypting the encrypted delivery time information enables the present time information and title key decryption key to be obtained. Use of the title key decryption key enables the encrypted title key information to be decrypted.

The information is transmitted between the reception/display control unit 10 and received information output display unit 31 on the basis of the IEEE 1394 standard in order to prevent the copy protect information or the like from being used improperly.

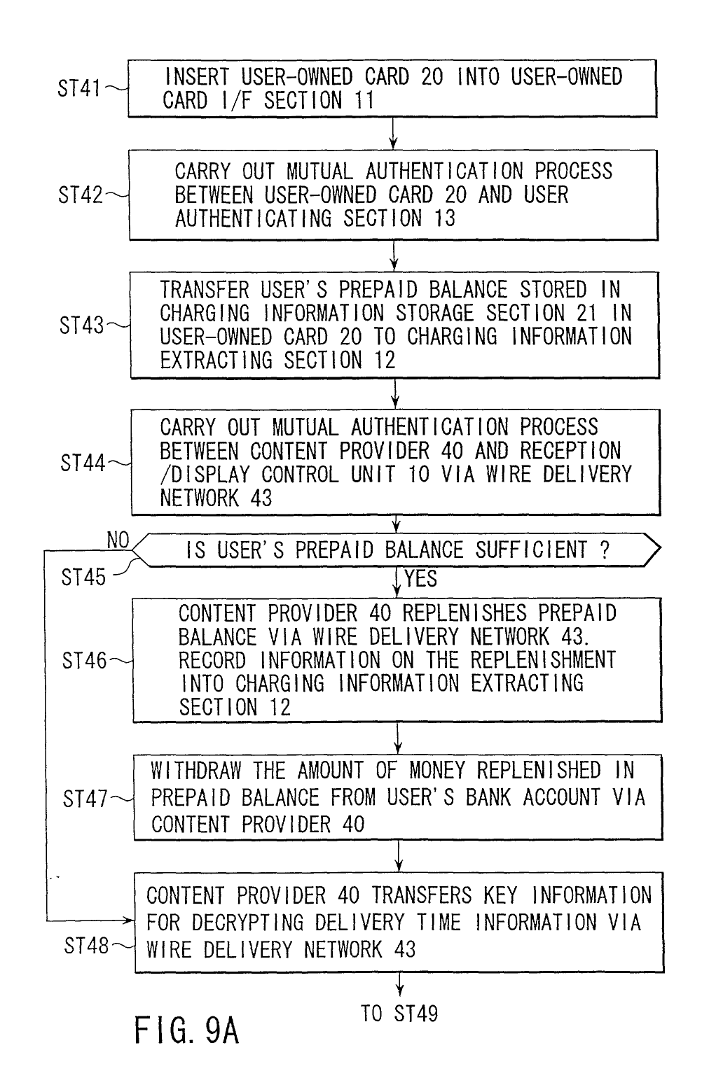

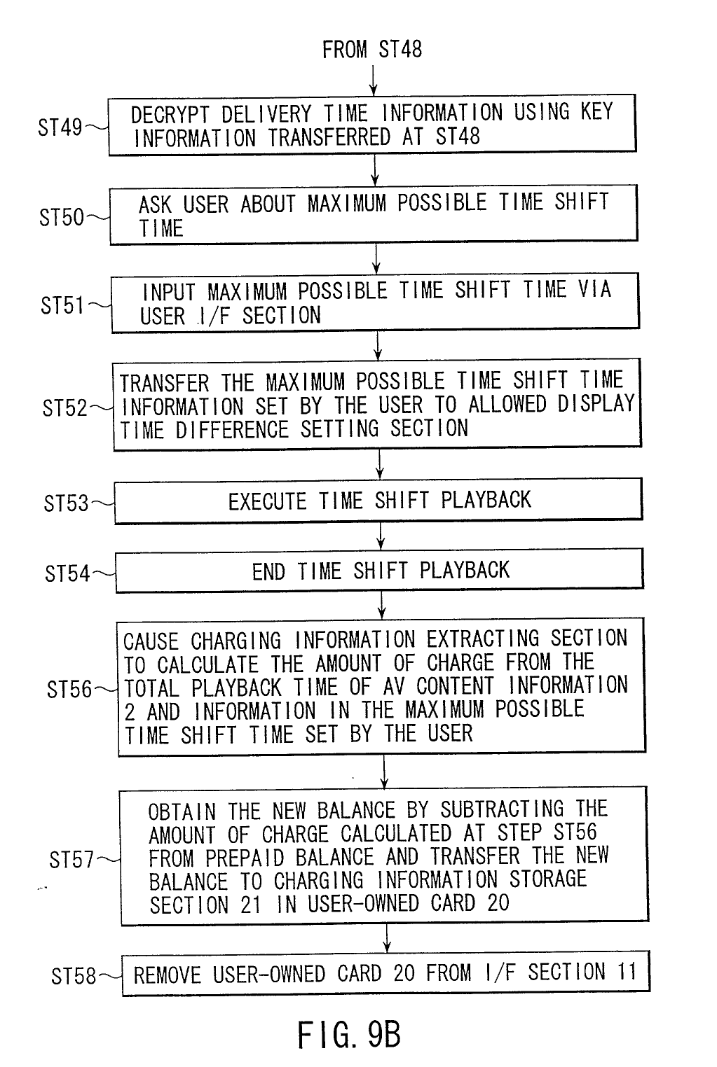

Next, referring to FIGS. 9A and 9B, a charging system in the information providing business according to the present invention will be explained.

When the user inserts the user-owned card 20 into the user-owned card I/F section 11 (step ST41), a mutual authentication process is carried out between the user-owned card 20 and user authenticating section 13. Next, the user's prepaid balance stored in the user key storage section 21 of the user-owned card 20 is transferred to the charging information extracting section 12 (step ST43). Then, a mutual authentication process is carried out between the content provider 40 and reception/display control unit 10 via the wire delivery network 43 (ST44).

After the content provider 40 has authenticated the user, it is judged whether the user's prepaid balance is sufficient (ST45). If the provider has judged that the prepaid balance is zero, the content provider 40 will replenish the prepaid balance via the wire delivery network 43. Information about the replenishment is recorded in the charging information extracting section 12 (step ST46).

Next, the replenished amount of money in the prepaid balance is withdrawn from the user's bank account via the content provider 40 (step ST47). The processes in step 46 and step T47 may be reversed.

Next, the content provider 40 transfers the key information for decrypting the delivery time information via the wire delivery network 43 (step ST48). Then, using the key information transferred at step ST48, the above-described decrypting is done on the basis of the delivery time information (step ST49). Thereafter, the user is prompted to enter the maximum possible time shift time (step ST50). The user enters the maximum time shift time from the user I/F section 17 (step ST51). Then, the maximum time shift time information set by the user is set in the allowed display time difference setting section 8 (step ST52).

Then, the time shift playback is carried out as described earlier at steps ST53 and ST54. Thereafter, the time shift playback is completed. Next, the charging information extracting section 12 calculates the charged amount of money from the total reproduction time of AV content information 2 and the maximum time shift time set by the user (step ST56). Then, the charged amount of money calculated at step ST56 is subtracted from the prepaid balance, thereby producing the new balance. Information about the new balance is transferred to the user key storage section 21 of the user-owned card 20 (step ST57). The user can then separate the user-owned card 20 from the user-owned card I/F section 11.

The above-described operation form is one example. It goes without saying that various operation forms may be realized in still other ways without departing from the spirit or essential character of the present invention. The method of realizing the time shift process with high security making use of the delivery time information and the charging method related to the time shift process may particularly be modified in various ways. For instance, in the present system, the maximum time shift time for one action (from starting a pause to canceling the pause) may be limited or the maximum totalized time shift time obtained by totalizing the maximum time shift time (the time totalized when a plurality of pause starts and cancellations are performed in one program) may be limited. These limitations may be combined.

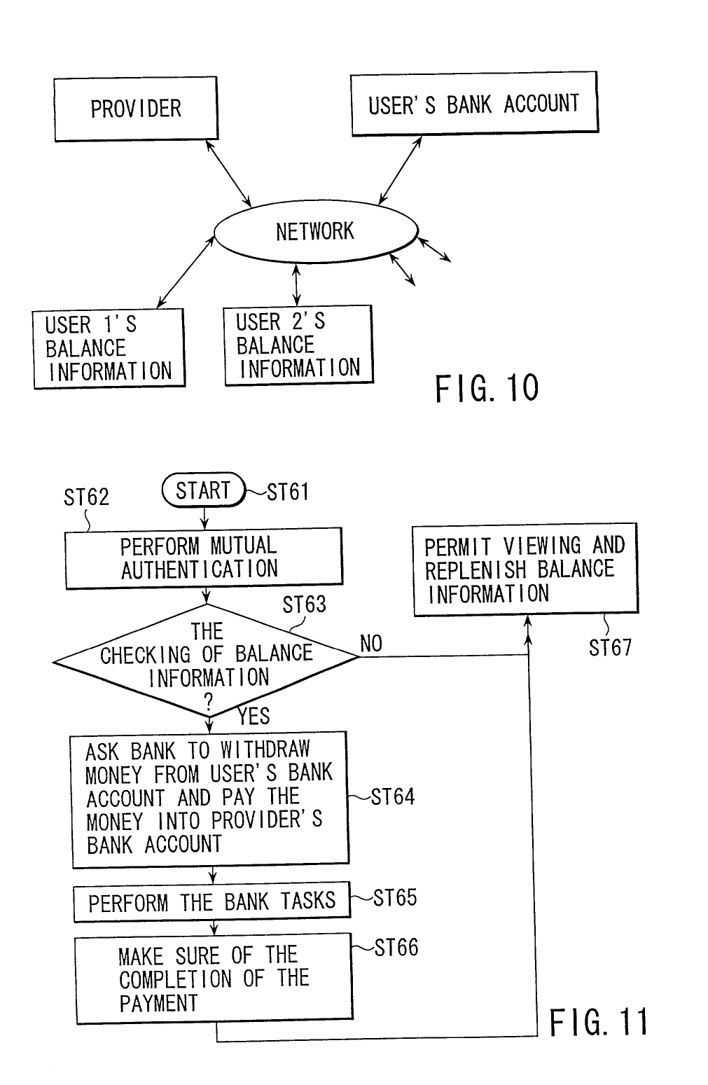

FIG. 10 shows the relationship between the network and the user side, between the network and the provider side, and between the network and the bank side. This relationship will be explained by reference to a flowchart in FIG. 11. When the time shift process is carried out, or when pay broadcasting is received, the mutual authentication process is carried out between the reception/display control unit 10 and content provider 40 and the above-described balance information is checked on the content provider 40 side (steps ST61, ST62, ST63). If the balance is sufficient, the viewing permit information will be transmitted to the reception/display control unit 10 at step ST67. If the balance is insufficient, the provider will ask the bank via the network to withdraw money from the user's bank account and pay the money into the provider's bank account (step ST65). When the payment complete information from the bank (step ST66) is received, control proceeds to step ST67, where the viewing permit information is transferred to the reception/display control unit 10 side.

As has been explained, the effects of the present invention are summarized as follows:

[Effects of Present Invention as Information Reproducing System]

S1. Illegal use is prevented and highly reliable time shift management is possible.

To compare with the effects of the present invention, consider the case of use of a method of incorporating a time shift management reference clock into the reception/display control unit 10 and managing the time shift display enable time making use of the time on the reference clock. Incorporating the reference clock into the reception/display control unit 10 enables the user to change the present time on the reference clock easily. As a result, it is possible to view the copy-prohibited information free of charge as many times as possible at any time.

With the method of the present invention, however, not only time shift is managed using the delivery time information 3 transmitted from the “transmission side,” but also the delivery time information 3 is encrypted, which prevents the user to change the time information easily.

S2. Using the delivery time information3, great security is assured for the time shift management.

The encrypted delivery time information 3 is not decrypted unless the user key information recorded in the user key storage section 21 of the user-owned card the specific user has is used. Furthermore, (1) the encrypted delivery time information 3 is decrypted; (2) the time difference between the delivery time and the display time is calculated; and (3) illegality is checked by comparing the value calculated in term (2) with the output of the totalized time shift computing section 9. In addition, (4) it is judged whether time shift display can be performed; and (5) the result of judging whether time shift display is possible is outputted. All the item (1) to item (5) are executed in the decrypting section 19 existing as a single chip.

Consequently, it is impossible to control the series of processes illegally from the outside, which assures a very high security.

S3. Updating the user key assures a still higher security.

Each time the user-owned card 20 is removed from the reception/display control unit 10, the charging process and the updating (or resetting) of the user key content necessary to decrypt the delivery time information 3 can be performed. This prevents a third party from using the user key information illegally, even when the third party steals the user key information from the user. Use of the method of the present invention assure an even higher security.

S4. Since the information recorded in the received information temporary storage section 18 (built in the unit) is deleted automatically, the hard disk will never be filled.

As shown in step ST11 of FIG. 7B, of the received information recorded in the received information temporary storage section 18, that exceeding the time shift display enable maximum time difference is deleted automatically in the embodiment of the present invention. As a result, even when time shift display is continued for a long time, it is possible to avoid a situation where the received information temporary storage section 18 is filled with the received information and the time shift display fails. This assures a stable time shift display for a long time.

S5. When the time shift display enable maximum time difference has been exceeded, processing can be done without giving a sense of incongruity to the user.

As shown in FIGS. 8A and 8B, the present invention displays the received information deleted from the received information temporary storage section 18 because it has exceeded the time shift display enable time difference, or the information prevented from being displayed for the user because the time shift display enable maximum time has been exceeded, although the received information is still left in the received information temporary storage section 18. When the user makes a request, the received information output display unit 31 displays the message “INFORMATION CANNOT BE DISPLAYED BECAUSE TIME SHIFT DISPLAY ENABLE MAXIMUM TIME DIFFERENCE HAS BEEN EXCEEDED” in the form of audio information or video information including still pictures. As a result, even when the information exceeding the time shift display enable maximum time difference is prevented from being displayed, giving the warning message prevents the user from having a sense of incongruity and enables the time shift process to be carried out without failure.

[Effects of Present Invention as Information Providing Business]

B1. The present invention has established a method of charging for provided information which is compatible with the time shift function. This method enables information providing business capable of time shift. The method also has the advantage that, even when the user visits the restroom or receives an unexpected visitor when receiving the information and interrupts the playback temporarily, the user can start the playback where it was interrupted. The method further has the advantage that, since the information providing service allows time shift, the content provider, the “transmission side,” can increase the amount of charges more than in the prior art, achieving an increase in the proceeds from information providing service.

B2. The time shift time can be managed on the “reception side” using only the encrypted delivery time information 3 transferred from the content provider, the “transmission side.” This makes it difficult to carry out an illegal process, such as changing the time shift time illegally by changing the clock. Since a charging method with a very low probability of illegality can be realized, the charges can be prevented from decreasing because of the user's illegal use, which enables a stable profit to be made on information providing service.

B3. Since time shift service can be provided only for specific users to be charged (who have user-owned cards), this helps make the users want to receive time shift service personally, even if paying money. As a result, the number of users who want expensive time shift service increases, leading to an increase in the proceeds from information providing service.

B4. When the time shift display enable maximum time difference has been exceeded, a warning is displayed for the user in the form of audio information or video information including still pictures. This makes the user want to lengthen the time shift display enable maximum time difference, even if paying higher service charges. As a result, the charges for information delivery increase, leading to an increase in the proceeds from information providing service.

The gist of the present invention will be summarized as follows.

(1) In a system including the transmission side which, of an information transmitting function and an information receiving function, has at least the former, the reception side which, of the information transmitting function and receiving function, has at least the latter, and at least a display function of displaying the information transmitted from the transmission side to the reception side, an information reproducing method is characterized by causing the transmission side to transmit transmission time information together with the information to be transmitted, and, when displaying the received information at a later time shifted from the time when the information was received, causing the reception side to manage at least the length of the time shift time making use of the transmission time information received in a temporally shifted manner and judge whether the received information is displayed in a time-shifted manner.

(2) Furthermore, the information reproducing method is characterized by giving a warning in sound or in pictures making use of the display function, when the length of the time shift time is shorter than the length of the time set on said reception side.

(3) Additionally, the information reproducing method is characterized in that, in the management, the time shift start or the earliest transmission time information 1 in the time shift period is stored for each time shift, the time shift time is calculated from the transmission time information 1 and received transmission time information 2 when the time shift is canceled, and the charges are calculated on the basis of the result of the calculation.

(4) Furthermore, the information reproducing method is characterized in that, in the management, the calculated time shift time is compared with the result of calculating the time shift time measured since the time shift was started, thereby checking whether illegality is present.

(5) Still furthermore, the information reproducing method is characterized in that, in the management, the length of the maximum time shift time set by the user is compared with the calculated time shift time, thereby judging whether the time shift time has been exceeded.

(6) Still furthermore, the information reproducing method is characterized in that, in the management, information about the length of the calculated time shift time is used in the charge calculating process.

(7) The information reproducing method is characterized in that, when the transmission side transfers at least display information, it transfers information about the delivery time when the information was delivered, together with the display information, and that the reception side is allowed to use the delivery time information as an element for calculating charges.

(8) Furthermore, when the reception side has the function of displaying the display information received from the transmission side, at a later time shifted from the time when the display information was received, the reception side is allowed to use the delivery information as an element for calculating the length of time shift time.

(9) Furthermore, the information reproducing method is characterized in that the delivery time information in item (7) or (8) is transferred as time information even after the transfer of the related information has been completed.

(10) Furthermore, the information reproducing method is characterized in that the delivery time information in item (9) is transferred continuously for at least the maximum time of the time shift.

(11) Furthermore, the information reproducing method is characterized in that the delivery time information is encrypted and then transferred.

As has been explained, with the present invention, it is possible to maintain high security, enable temporary copying, and thereby realize a time shift function, and charge properly for service even in a pay information providing service system which charges for service each time the received information is decrypted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. In a transmitting and receiving system including
the transmission side which, of an information transmitting function and an information receiving function, has at least the former,
the reception side which, of the information transmitting function and receiving function, has at least the latter, and
at least a display function of displaying the information transmitted from said transmission side to the reception side,
an information reproducing method comprising:
the step of causing said transmission side to transmit transmission time information together with the information to be transmitted, and
the step of, when displaying said received information at a later time shifted from the time when the information was received,
causing said reception side to manage at least the length of the time shift time making use of said transmission time information received in a temporally shifted manner and judge whether said received information is displayed in a time-shifted manner.

2. The information reproducing method according to claim 1, further comprising the step of giving a warning in sound or in pictures making use of said display function, when the length of said time shift time is shorter than the length of the time set on said reception side.

3. The information reproducing method according to claim 1, further comprising the step of calculating charges according to the length of said time shift time.

4. An information providing business method comprising:
the step of, when transferring at least display information, causing the transmission side to transfer information about the delivery time when the information was delivered, together with said display information; and
the step of causing the reception side to receive said delivery time information and using the delivery time information as an element for calculating at least charges.

5. The information providing business method according to claim 4, further comprising the step of, when said reception side has the function of displaying said display information received from said transmission side, at a later time shifted from the time when the display information was received, causing said reception side to use said delivery information as an element for calculating the length of time shift time.

6. An information reproducing method of receiving the encrypted content sent from the transmission side and information about the transmission time of the encrypted content and reproducing them, said information reproducing method comprising:
step A of decrypting said encrypted content;
step B of outputting the decrypted content on a display section;
step C of, when a temporary interrupt instruction is given, stopping said decryption and display and causing a temporary storage section to store said encrypted content and transmission time information received;
step D of measuring the length of time since said temporary storage section started to store said encrypted content and said transmission time information;
step E of, when said temporary interrupt instruction is canceled, determining the length of the time difference between newly received transmission time information and the oldest transmission information stored in said temporary storage section;
step F of determining the difference between the length of time measured at said step D and the length of the time difference determined at said step E and judging whether the difference is within a specific value;
step G of, when said difference determined at said step F is within the specific value, decrypting the encrypted content stored in said temporary storage section; and
step H of, when said difference determined at said step F has exceeded the specific value, outputting a warning signal.

7. The information reproducing method according to claim 6, wherein said step G includes step G1 of calculating charging information according to said difference.

8. The information reproducing method according to claim 6, wherein said step G includes step G1 of calculating charging information according to said specific value.

9. The information reproducing method according to claim 7 or 8, further comprising step I of transmitting said charging information to said transmission side.

10. The information reproducing method according to claim 7 or 8, wherein said step G1 includes step G2 of subtracting the value of said charging information from the value of the balance information read from a user-owned card to find the remainder and writing information about the new balance into said user-owned card.

11. The information reproducing method according to claim 6, further comprising step I of inputting said specific value to a maximum time shift time setting section.

12. The information reproducing method according to claim 11, wherein said step I is to input said specific value to said maximum time shift time setting section in response to the user's operation.

13. The information reproducing method according to claim 11, wherein said step I is to input said specific value sent from said transmission side to said maximum time shift time setting section.

14. An information providing business method of causing said reception said to receive said charging information obtained and transmitted in the information reproducing method according to claim 7 or 8.

15. An information providing business method of transmitting said encrypted content and said transmission time information related to claim 6 to said reception side.

16. An information providing business method of transmitting said specific value related to claim 11.
